(19) United States
(12) Patent Application Publication
(10) Pub. No.: US 2024/0399930 A1
(43) Pub. Date: Dec. 5, 2024

(54) Method for Heating an Electrical Energy Store of an at Least Partly Electrically Operated Motor Vehicle, Computer Program Product, Heating Device, and Electrical Energy Store

(71) Applicant: Bayerische Motoren Werke Aktiengesellschaft, Muenchen (DE)

(72) Inventors: Christian SCHARDAX, Garsten Nord (AT); Christopher SCHMUDLACH, Gauting (DE)

(21) Appl. No.: 18/700,392

(22) PCT Filed: Sep. 8, 2022
(86) PCT No.: PCT/EP2022/075004

§ 371 Date: Apr. 11, 2024

(30) Foreign Application Priority Data
Oct. 27, 2021 (DE) 10 2021 127 940.2

(51) Int. Cl. B60L 58/27; B60L 58/21; H01M 10/637

(52) U.S. Cl. CPC B60L 58/27; B60L 58/21; H01M 10/637; B60L 2210/10

(57) ABSTRACT

The present disclosure relates to a method for heating an electrical energy store of an at least partly electrically operated motor vehicle by means of a heating device of the electrical energy store, in which the electrical energy store provided in a manner having at least a first storage module and a second storage module is heated depending on a control signal of an electronic computing unit of the heating device, wherein an intermediate tap is provided between the first and second storage modules and the control signal is generated in such a way that the second storage module is energized with electrical energy from the first storage module and, on the basis of an internal resistance of the second storage module during the energization, heat for heating purposes is generated in the second storage module, and vice versa.

### BACKGROUND AND SUMMARY

The invention relates to a method for heating an electrical energy store of an at least partly electrically operated motor vehicle by means of a heating apparatus of the electrical energy store. Furthermore, the invention relates to a computer program product, a heating apparatus and an electrical energy store.

At least partly electrically operated motor vehicles and fully electrically operated motor vehicles, respectively, are already known from the prior art. These motor vehicles have an electrical energy store which, for example, is made up of a multiplicity of cell modules. The cell modules can in turn have a multiplicity of battery cells, for example lithium-ion cells. It is already known that, in order to be able to achieve correct output, these battery cells have to be heated in the winter time, for example, in order to reach a predefined temperature. Should this not be carried out, output losses of the electrical energy store may be able to be recorded. For this purpose, various heating concepts are already known, in particular in the form of heating systems external to the cell modules or liquid-containing heating systems.

DE 10 2016 208 063 A1 discloses a heatable battery comprising a battery cell having an anode and a cathode, an anode connection connected to the anode, and a cathode connection connected to the cathode. The battery cell has a heating element and a connection for applying a voltage potential to the heating element. The heating element is connected to one of the anode connection and the cathode connection. Moreover, the battery cell comprises a controllable switch which is arranged between the connection for applying the voltage potential to the heating element and the other of the anode connection and the cathode connection.

DE 10 2013 017 343 A1 relates to a method for heating battery cells of a battery, in particular of a high-voltage battery, in a vehicle having an electrical drive, wherein the electrical vehicle drive can also be used as a generator, having the steps of providing a battery, in particular a high-voltage battery, having at least one battery cell, wherein the battery has an electrical heating device for heating the at least one battery cell, and providing a control unit by means of which distribution of an electrical current obtained by recuperation to the at least one battery cell and electrical heating device can be controlled, and routing at least a portion of the electrical current obtained by recuperation to the at least one battery cell, wherein, once the maximum charging capacity of the at least one battery cell is reached, a remaining proportion of the electrical current which is not able to be used for charging the at least one battery cell is routed to the electrical heating device.

An object of the present invention is to provide a method, a computer program product, a heating apparatus and an electrical energy store, by means of which the electrical energy store can be heated efficiently.

This object is achieved by a method, a computer program product, a heating apparatus and an electrical energy store according to the independent patent claims. Advantageous configurations are specified in the dependent claims.

One aspect of the invention relates to a method for heating an electrical energy store of an at least partly electrically operated motor vehicle by means of a heating apparatus of the electrical energy store, in which method the electrical energy store, which is provided at least with a first storage module and a second storage module, is heated on the basis of a control signal from an electrical computing device of the heating apparatus.

Provision is made for an intermediate tap to be provided between the first storage module and the second storage module and for the control signal to be generated in such a way that the second storage module is energized with electrical energy from the first storage module and, based on the internal resistance of the second storage module during the energization, for heat for heating purposes to be generated in the second storage module, and vice versa.

In particular, provision is thus furthermore made for the first storage module to be energized by means of electrical energy from the second storage module and, based on the internal resistance in the first storage module during the energization, for heat for heating purposes to be generated in the first storage module.

This allows the electrical energy store to be able to be heated efficiently. In particular, the heating is carried out directly within the storage modules and so there is no heat loss. Based on the internal resistance, which in particular is an ohmic resistance, heat, which can now be used efficiently, is produced during the energization in order to carry out the heating of the storage modules. No additional heating structures are thus necessary in order to carry out heating. Efficient heating can thus already be carried out, for example, even in the case of a low heat output, since hardly any heat loss should be recorded and the heating is carried out directly within the cell modules.

In particular, provision is thus made for the use of two storage modules which form a common on-board electrical system, in particular a high-voltage on-board electrical system, wherein the heating can be carried out without any significant output loss due to energization of the respective storage modules. In this case, one half of the store is discharged and the second half of the store is charged. The electronic computing device can carry out the energization, for example, at a particular frequency in order to achieve optimal and aging-optimal heating of the storage modules or of the battery cells.

In particular, provision is made in this case for the electrical energy store to be provided for 800 volts, for example, wherein each of the storage modules can then have 400 volts. In other words, the intermediate tap between the storage modules takes place such that both storage modules can have a voltage level of 400 volts. The intermediate tap and the positive pole and negative pole of the electrical energy store are then coupled to the electronic computing device or to a switching device, wherein, on the basis of the control signal, electrical energy of the first storage module is then in turn used to energize the second storage module and, on the basis of a further control signal, a reverse procedure is then in turn used.

According to one advantageous configuration, heat output is adjusted on the basis of a frequency of the energization in the control signal. In particular, the frequency between the switching-over between the heating of the second storage module and of the first storage module can be recorded. In other words, the frequency describes the switching-over between the energization of the first storage module and of the second storage module. In particular, the frequency is thus adapted, for example, on the basis of an external temperature or a present temperature and/or on the basis of the present temperature of the electrical energy store. In particular, at a higher frequency, a higher internal resistance within the storage modules or the battery cells can be recorded. A higher heat output is in turn produced at a higher internal resistance. In particular, provision can thus be made, the lower the temperature of the battery cells, the higher a frequency applied to the control signal in order to obtain a higher heat output. The heat output can thus be correspondingly adapted depending on predefined conditions.

Moreover, it has proven to be advantageous if the intermediate tap is coupled to a DC-DC voltage converter and the energization is carried out by virtue of the electronic computing device using the control signal by controlling the DC-DC voltage converter. In particular, the DC-DC voltage converter can be coupled to the high-voltage side of the electrical energy store and to a low-voltage side, for example by means of a 12-volt battery. In this case, the DC-DC voltage converter is formed on the primary side in particular with dual switching elements, such that a redundant system can be provided; should one of the switching elements fail, for example, the low-voltage on-board electrical system can thus still reliably be operated by the DC-DC voltage converter, and vice versa. The DC-DC voltage converter is in particular already a component that is installed in the on-board electrical system and so it can be used in a component-saving manner in order to be able to carry out the method according to the invention.

In another advantageous configuration, the DC-DC voltage converter is additionally provided to electrically couple a first energy network of the motor vehicle having a first voltage to a second energy network of the motor vehicle having a second voltage. As already mentioned, the first voltage is, for example, a high voltage provided by the electrical energy store, in particular by the first storage module and the second storage module. The second energy network is in particular a low-voltage energy network, for example a 12-volt low-voltage network. The first energy network can be used to operate, for example, a drive device of the motor vehicle. The second energy network can be used to operate, for example, an on-board electrical system. The DC-DC voltage converter can thus be used to carry out both the heating and additionally also the coupling between the first energy network and the second energy network.

It is likewise advantageous if the first energy network is provided as a high-voltage on-board electrical system and the second energy network is provided as a low-voltage network. In this case, the first energy network can in particular likewise be provided with at least 400 volts, in particular with at least 800 volts, and the second energy network can be provided with at least 12 volts. In particular, the first energy network can thus be provided for a drive device of the at least partly electrically operated motor vehicle. The motor vehicle can in particular also be a fully electrically operated motor vehicle.

Moreover, it has proven to be advantageous if the control signal for heating the storage modules is adjusted on the basis of the state of aging of the first storage module and/or of the second storage module. For example, the electronic computing device can be designed to determine the state of aging. On the basis thereof, it is then in turn necessary for a corresponding heating to be adapted in accordance with the state of aging. The state of aging can thus be taken into consideration and more efficient heating of the storage modules can be carried out.

The presented method is in particular a computer-implemented method. A further aspect of the invention therefore relates to a computer program product having program code means which, when the program code means are processed by an electronic computing device, cause the electronic computing device to carry out a method according to the preceding aspect. A yet further aspect of the invention relates to a computer-readable storage medium having the computer program product. The computer program product can also be referred to just as computer program.

Furthermore, the invention also relates to a heating apparatus for heating an electrical energy store of an at least partly electrically operated motor vehicle, having at least one electronic computing device, wherein the heating apparatus is designed to carry out a method according to the preceding aspect. In particular, the method is carried out by means of the heating apparatus.

Furthermore, the invention also additionally relates to an electrical energy store for an at least partly electrically operated motor vehicle, having at least a first storage module, a second storage module, an intermediate tap and having a heating apparatus according to the preceding aspect.

A yet further aspect of the invention also relates to a motor vehicle having an electrical energy store according to the preceding aspect. In this case, the motor vehicle can be designed to be at least partly electrically operated or fully electrically operated.

Advantageous configurations of the method can be regarded as advantageous configurations of the computer program product, of the heating apparatus, of the electrical energy store and of the motor vehicle. For this purpose, the heating apparatus, the electrical energy store and the motor vehicle have substantive features which allow the method to be carried out.

Further features of the invention are evident from the claims, the figures and the description of the figures. The features and combinations of features mentioned above in the description, and the features and combinations of features mentioned below in the description of the figures and/or shown in the figures themselves, cannot only be used in the respectively specified combination but also in other combinations or by themselves.

### BRIEF DESCRIPTION OF THE DRAWINGS

The invention will now be explained in more detail on the basis of a preferred exemplary embodiment and with reference to the drawings, in which:

FIG. 1 shows a schematic side view of one embodiment of a motor vehicle having one embodiment of an electrical energy store; and

FIG. 2 shows a schematic circuit diagram according to one embodiment of an electrical energy store having one embodiment of a heating apparatus.

### DETAILED DESCRIPTION OF THE DRAWINGS

Identical or functionally identical elements are provided with the same reference signs in the figures.

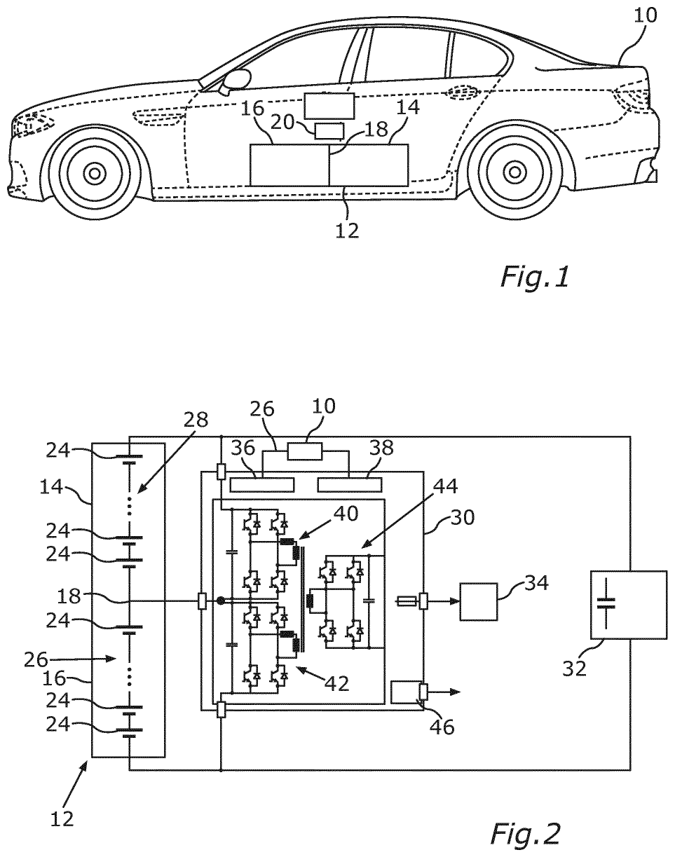

FIG. 1 shows a schematic side view of one embodiment of a motor vehicle 10 having one embodiment of an electrical energy store 12. The motor vehicle 10 can, for example, be in the form of an at least partly electrically operated motor vehicle or a fully electrically operated motor vehicle. The electrical energy store 12 can, for example, be in the form of a high-voltage battery. The electrical energy store 12 can, for example, provide electrical energy for a drive device of the motor vehicle 10. Furthermore, the electrical energy store 12 can also provide energy for an on-board electrical system of the motor vehicle 10.

In the present exemplary embodiment, the electrical energy store 12 has a first storage module 14 and a second storage module 16. Furthermore, in the present case, the electrical energy store 12 has an intermediate tap 18. Furthermore, it is in particular shown that the electrical energy store can also have a heating apparatus 20. The heating apparatus 20 is designed to heat the electrical energy store 12. For this purpose, the heating device 20 has in particular an electronic computing device 22.

FIG. 2 shows a schematic electrical circuit diagram according to one embodiment of the electrical energy store 12. In the present exemplary embodiment, it is in particular shown that a respective storage module 14, 16 can have a multiplicity of battery cells 24. During the method for heating the electrical energy store 12, the electrical energy store 12, which has at least the first storage module 14 and the second storage module 16, is heated on the basis of a control signal 26 from the electronic computing device 22. In this case, provision is made for the intermediate tap 18 to be provided between the first storage module 14 and the second storage module 16 and for the control signal 26 to be generated in such a way that the second storage module 16 is energized with electrical energy from the first storage module 14 and, based on the internal resistance 28 of the second storage module 16 during the energization, for heat for heating purposes to be generated in the second storage module 16. Furthermore, provision is subsequently made for the first storage module 14 to be energized with electrical energy from the second storage module 16 and, based on the internal resistance 28 of the first storage module 14 during the energization, for heat for heating purposes to be generated in the first storage module 14. In particular, this takes place alternately. In other words, for example, the second storage module 16 is energized first and the first storage module 14 is energized thereafter. This then in particular involves a frequency of the control signal 26.

In other words, a frequency-dependent switching-over between the energization of the first storage module 14 and of the second storage module 16 takes place. In particular, the heat output for the first storage module 14 and the second storage module 16 can in turn be adjusted on the basis of the frequency of the energization. In particular, the frequency can then in turn be adapted on the basis of environmental conditions, for example an environmental temperature and a present temperature of the electrical energy store 12, and the heat output can thus be adapted. In particular, a higher frequency results in a higher internal resistance within the storage modules 14, 16 and so more heat is generated at a higher frequency and the heat output is thus increased. In other words, the warmer the electrical energy store 12, the less high the frequency at which the method according to the invention is carried out.

In particular, the storage modules 14, 16 are thus heated in anti-parallel.

In particular, as FIG. 2 shows, the intermediate tap 18 is coupled to a DC-DC voltage converter 30 and the energization is carried out by virtue of the electronic computing device 22 using the control signal 26 by controlling the DC-DC voltage converter 30. In this case, the DC-DC voltage converter 30 is in particular designed additionally to electrically couple a first energy network 32, in particular on the primary side, having a first voltage to a second energy network 34, in particular on the secondary side, having a second voltage. In this case, the first energy network 32 can in particular be provided as a high-voltage network and the second energy network 34 can be provided as a low-voltage network. In particular, the first energy network 32 can be provided with at least 400 volts, in particular with at least 800 volts, and the second energy network 34 can be provided with at least 12 volts. For example, the first storage module 14 can provide 400 volts and the second storage module 16 can likewise provide 400 volts, such that the first energy network is provided with in particular 800 volts. In this case, the electronic computing device 22 can control both a high-voltage controller 36 and a low-voltage controller 38.

Furthermore, provision can in particular be made for the control signal 26 for heating the storage modules 14, 16 to be adjusted on the basis of a state of aging of the first storage module 14 and/or of the second storage module 16.

In particular, provision is thus made, for example, through the use of the two storage modules 14, 16 each having 400 volts with the same output, for the DC-DC voltage converter 30 to have, for example, a first converter part 40 and a second converter part 42 which are each designed for 400 volts. In this case, a third converter part 44 is designed for a low-voltage side. In particular, electrical coupling between the first converter part 40 and the third converter part 44 and between the second converter part 42 and the third converter part 44 with redundancy is thus proposed. The intermediate tap 18 is already installed in the motor vehicle for this purpose. The two converter parts 40, 42 are coupled to the 800-volt output and can carry out energization of the first storage module 14 and of the second storage module 16 without any significant output loss. In this case, one half of the store is discharged and the second half of the store is charged. The DC-DC voltage converter 30 can carry out the energization at a predefined frequency in order to achieve optimal and aging-optimal heating of the storage modules 14, 16.

Furthermore, the DC-DC voltage converter 30 can have a communication module 46 which can communicate, for example, via a CAN network of the motor vehicle 10.

### LIST OF REFERENCE SIGNS

10 motor vehicle
12 electrical energy store
14 first storage module
16 second storage module
18 intermediate tap
20 heating apparatus
22 electronic computing device
26 control signal
28 internal resistance
30 DC-DC voltage converter
32 first energy network
34 second energy network
36 high-voltage controller
38 low-voltage controller
40 first converter part
42 second converter part
44 third converter part
46 communication module

1-10. (canceled)

11. A method for heating an electrical energy store of an at least partly electrically operated motor vehicle, the method comprising:
heating the electrical energy store with a heating apparatus of the electrical energy store, where the electrical energy store is heated on the basis of a control signal from an electronic computing device of the heating apparatus, the electrical energy store comprising at least a first storage module and a second storage module and an intermediate tap between the first storage module and the second storage module;
wherein the electronic computing device generates the control signal such that the second storage module is energized with electrical energy from the first storage module, and such that first storage module is energized with electrical energy from the second storage module;
wherein, based on an internal resistance of the second storage module during the energization of the second storage module, heat for heating the second storage module is generated in the second storage module; and
wherein, based on an internal resistance of the first storage module during energization of the first storage module, heat for heating the first storage module is generated in the first storage module.

12. The method of claim 11, wherein the heat output for at least one of the first storage module or the second storage module is adjusted on the basis of a frequency of the energization in the control signal.

13. The method of claim 11, wherein:
the intermediate tap is coupled to a DC-DC voltage converter; and
energization of at least one of the first storage module or the second storage module is carried out by virtue of the electronic computing device using the control signal by controlling the DC-DC voltage converter.

14. The method according to claim 13, wherein the DC-DC voltage converter electrically couples a first energy network of the motor vehicle having a first voltage to a second energy network of the motor vehicle having a second voltage.

15. The method according to claim 14, wherein the first energy network is provided as a high-voltage network and the second energy network is provided as a low-voltage network.

16. The method according to claim 15, wherein the first energy network is provided with at least 400 volts, and the second energy network is provided with at least 12 volts.

17. The method of claim 16, wherein the first energy network is provided with at least 800 volts

18. The method of claim 11, wherein the control signal for heating the first and second storage modules is adjusted on the basis of at least one of a state of aging of the first storage module or a state of aging of the second storage module.

19. A computer readable storage medium comprising program code for heating an electrical energy store of an at least partly electrically operated motor vehicle, the program code, when executed by an electronic computing device, direct the electronic computing device to:
heat the electrical energy store with a heating apparatus of the electrical energy store, where the electrical energy store is heated on the basis of a control signal from the electronic computing device of the heating apparatus, the electrical energy store comprising at least a first storage module and a second storage module and an intermediate tap between the first storage module and the second storage module;
wherein the electronic computing device generates the control signal such that the second storage module is energized with electrical energy from the first storage module, and such that first storage module is energized with electrical energy from the second storage module;
wherein, based on an internal resistance of the second storage module during the energization of the second storage module, heat for heating the second storage module is generated in the second storage module; and
wherein, based on an internal resistance of the first storage module during energization of the first storage module, heat for heating the first storage module is generated in the first storage module.

20. A heating apparatus for heating an electrical energy store of an at least partially electrically operated motor vehicle, the heating apparatus comprising at least one electronic computing device configured to:
heat the electrical energy store, where the electrical energy store is heated on the basis of a control signal from the at lease one electronic computing device of the heating apparatus, the electrical energy store comprising at least a first storage module and a second storage module and an intermediate tap between the first storage module and the second storage module;
wherein the at lease one electronic computing device generates the control signal such that the second storage module is energized with electrical energy from the first storage module, and such that first storage module is energized with electrical energy from the second storage module;
wherein, based on an internal resistance of the second storage module during the energization of the second storage module, heat for heating the second storage module is generated in the second storage module; and
wherein, based on an internal resistance of the first storage module during energization of the first storage module, heat for heating the first storage module is generated in the first storage module.

21. An electrical energy store for an at least partially electrically operated motor vehicle, the electrical energy store comprising:
a first storage module;
a second storage module;
an intermediate tap between the first storage module and the second storage module; and
a heating apparatus comprising at least one electronic computing device configured to:
heat the electrical energy store with the heating apparatus, where the electrical energy store is heated on the basis of a control signal from the at least one electronic computing device of the heating apparatus;
wherein the at least one electronic computing device generates the control signal such that the second storage module is energized with electrical energy from the first storage module, and such that first storage module is energized with electrical energy from the second storage module;
wherein, based on an internal resistance of the second storage module during the energization of the second storage module, heat for heating the second storage module is generated in the second storage module; and
wherein, based on an internal resistance of the first storage module during energization of the first storage module, heat for heating the first storage module is generated in the first storage module.
